(19) United States
(12) Patent Application Publication
(10) Pub. No.: US 2006/0023355 A1
(43) Pub. Date: Feb. 2, 2006

(54) Head drum assembly for magnetic recording and reproducing apparatus

(75) Inventors: Myoung-joon Kim, Suwon-si (KR); Chung-hum Baik, Suwon-si (KR); Bong-joo Kim, Suwon-si (KR); Jun-young Kim, Suwon-si (KR); Young-ho Cho, Suwon-si (KR); Jae-kab Seo, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/143,591

(22) Filed: Jun. 3, 2005

(30) Foreign Application Priority Data
Jul. 29, 2004 (KR) 2004-59544

(51) Int. Cl. G11B 15/60; G11B 5/027

(52) U.S. Cl. 360/130.24

(57) ABSTRACT

A head drum assembly of a magnetic recording and reproducing apparatus includes a fixed drum secured to a shaft and a rotary drum rotatably fitted on the shaft to be opposite to the fixed drum. A motor rotor is supported in the rotary drum. A stator is installed on the fixed drum to be opposite to the motor rotor. A yoke is secured to the fixed drum so that a predetermined air gap is provided between the stator and the yoke.

### CROSS-REFERENCE TO RELATED APPLICATIONS

This application claims the benefit under 35 U.S.C. § 119 (a) of Korean Patent Application No. 2004-59544 filed on Jul. 29, 2004, the entire contents of which are hereby incorporated by reference.

### FIELD OF THE INVENTION

The present invention relates to a head drum assembly for a magnetic recording and reproducing apparatus.

### DESCRIPTION OF THE RELATED ART

In general, a magnetic recording and reproducing apparatus is an appliance for recording information to and/or reproducing information from a recording medium such as a magnetic tape. Examples include video cassette tape recorders (VCR) and camcorders.

Such a magnetic recording and reproducing apparatus includes a main deck, a sub-deck slidably installed on the main deck, a head drum assembly rotatably installed on the main deck for recording information to and/or reproducing from a magnetic tape, and tape guide means for guiding the running of the magnetic tape.

The head drum assembly is typically installed to be rotatable in a tilted state by a predetermined angle in relation to the main assembly so that its recording and reproducing capability can be improved. An example of such a head drum assembly is illustrated in FIG. 1.

Referring to FIG. 1, a fixed drum 11 is fitted on a shaft 10. A rotary drum 12 is rotatably fitted on the shaft 10 to be opposite the fixed drum 11. A magnetic head 13 for scanning a running magnetic tape and recording and reproducing information is supported on the head drum 12. In addition, a drum cover 14 is located on the rotary drum 12 and secured to the shaft 10. The rotary drum 12 and the drum cover 14 are respectively provided with a rotary transfer 15 and a fixed transfer 16 for transferring a signal read by the magnetic signal.

The rotary drum 12 is equipped with a motor rotor 17, and the fixed drum 11 is equipped with a stator 18 opposite to the motor rotor 17. The motor rotor 17 is a magnet that generates driving force for rotating the rotary drum 12 by cooperation with the stator 18.

In addition, a yoke 19 is installed on the bottom of the stator 18. The yoke 19 is provided to focus magnetic force generated by the stator, thereby improving a current characteristic for rotating the rotary drum 12.

There is a recent trend to miniaturize magnetic recording and reproducing apparatuses employing a head drum assembly as mentioned above. Accordingly, a lot of restrictions are imposed on a size of a battery used in such an apparatus. Nonetheless, various attempts have been made to increase the expected life span of batteries.

Accordingly, a need exists for magnetic recording and reproducing apparatus having improved current consumption characteristics for driving a head drum of the apparatus, thereby extending battery life.

### SUMMARY OF THE INVENTION

Accordingly, an object of the present invention is to provide a head drum assembly of a magnetic recording and reproducing apparatus, wherein the head drum has a structure improved to reduce current consumption.

A head drum assembly of a magnetic recording and reproducing apparatus includes a fixed drum secured to a shaft, and a rotary drum rotatably fitted on the shaft to be opposite to the fixed drum. A motor rotor is supported in the rotary drum. A stator is installed on the fixed drum to be opposite to the motor rotor. A yoke is secured to the fixed drum so that a predetermined air gap is provided between the stator and the yoke.

The air gap is ranged preferably from about 0.2 mm to about 0.4 mm.

The fixed drum may include a stator seating part formed on a surface of the fixed drum faced to the rotary drum so that the stator is seated on the stator seating part, and a yoke reception part formed to be stepped from the stator seating part and receiving the yoke.

The depth of the yoke reception part may be larger than the thickness of the yoke.

Additionally, the depth of the yoke reception part may be ranged preferably from about 0.7 mm to about 1.1 mm.

According to another aspect of the present invention, a magnetic recording and reproducing apparatus includes a deck and a head drum assembly installed on the deck. The head drum assembly inlcudes a fixed drum secured to a shaft. A rotary drum is rotatably fitted on the shaft to be opposite to the fixed drum. A motor rotor is supported in the rotary drum. A stator is installed on the fixed drum to be opposite to the motor rotor. A yoke is secured to the fixed drum so that a predetermined air gap is provided between the stator and the yoke.

Other objects, advantages and salient features of the invention will become apparent from the following detailed description, which, taken in conjunction with the annexed drawings, discloses preferred embodiments of the invention.

### BRIEF DESCRIPTION OF THE DRAWINGS

The above aspects and features of the present invention will be more apparent from the description for certain embodiments of the present invention taken with reference to the accompanying drawings, in which:

FIG. 1 is a cross-sectional view showing a conventional head drum assembly of a magnetic recording and reproducing apparatus;

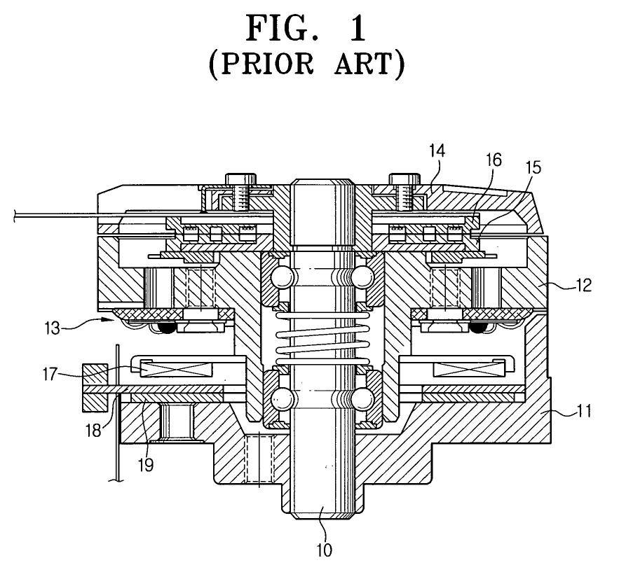

FIG. 2 is a schematic cross-sectional view showing a head drum assembly of a magnetic recording and reproducing apparatus according to an embodiment of the present invention; and

FIG. 3 is a elevational view in cross section of the fixed drum extracted from FIG. 2.

Throughout the drawings, like reference numerals will be understood to refer to like parts, components and structures.

### DETAILED DESCRIPTION OF EXEMPLARY EMBODIMENTS

A magnetic recording and reading apparatus according to exemplary embodiments of the present invention will be described in detail with reference to the drawings. In the following description, the same drawing reference numerals are used for the same elements even in different drawings. The matters defined in the description, such as a detailed construction and elements thereof, are provided to assist in a comprehensive understanding of the invention. Thus, it is apparent that the present invention may be carried out without those defined matters. Also, well-known functions or constructions are omitted to provide a clear and concise description of the exemplary embodiments of the present invention.

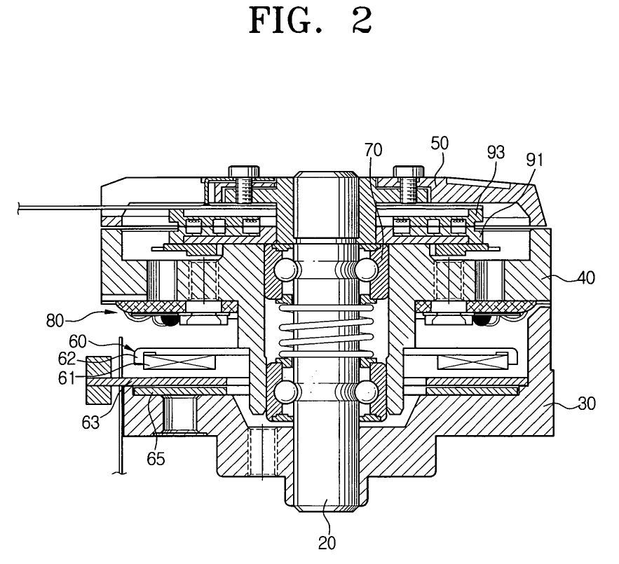

Referring to FIG. 2, the head drum assembly of a magnetic recording and reproducing assembly according to exemplary embodiments of the present invention includes a fixed drum 30 secured to a shaft 20, a rotary drum 40 rotatably installed above the fixed drum 30, a drum cover 50 installed above the rotary drum 40, and a driving unit 60 for driving the rotary drum 40.

The fixed drum 30 is fitted on and secured to the shaft 20. The rotary drum 40 is fitted on the shaft 20 in a stacked relation with and opposite to the rotary drum 40. A bearing 70 is disposed between the rotary drum 40 and the shaft 20.

Additionally, the rotary drum 40 supports a magnetic head 80 in such a manner that the magnetic head 80 scans a running magnetic tape to record information into or to reproduce information from the magnetic tape.

The drum cover 50 positioned above the rotary drum 40 is fitted on and secured to the shaft 20. The drum cover 50 and the rotary drum 40 are provided with a fixed transfer 93 and a rotary transfer 91, respectively, for transferring information read by the magnetic head 80.

The driving unit 60 includes a motor rotor 61 installed on the rotary drum 40 and a motor stator 63 installed on the fixed drum 30.

The motor rotor 61 is a donut-shaped magnet, which is supported by a rotor case 62 installed on the rotary drum 40.

The motor stator 63 is fitted on the fixed drum 30 to be spaced from and opposite to the motor rotor 61. The motor stator 63 may be a structure provided with a fine pattern coil formed on a PCB.

Further, a yoke 65 is installed on the bottom side of the motor stator 63. The yoke 65 is fixed by being attached to the fixed drum 30 with adhesive or the like.

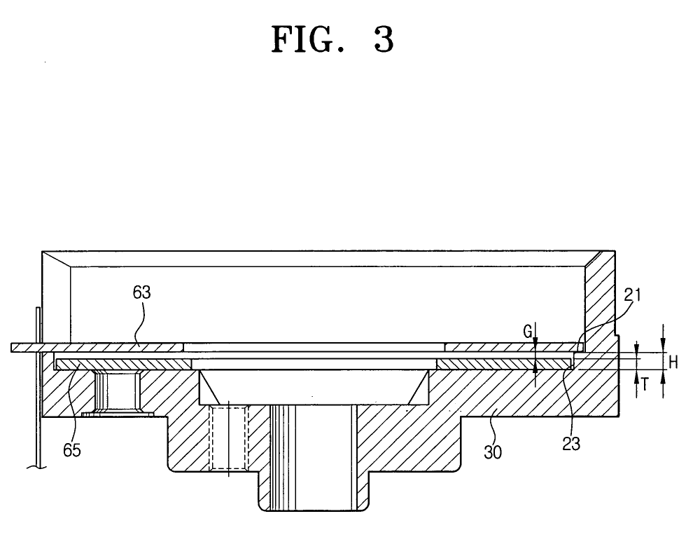

Meanwhile, referring to FIG. 3, a predetermined air gap G is formed between the motor stator 63 and the yoke 65. The air gap G is preferably formed in the range of about 0.2 to about 0.4 mm. To provide the air gap G like this, it is advantageous if the fixed drum 20 is constructed as follows.

Specifically, the top of the fixed drum 30, which is faced to the rotary drum, is formed with a stator seating part 21 on which the motor stator 63 is seated. Additionally, a yoke reception part that receives the yoke 65 is formed in a predetermined depth inwardly from the stator seating part 21. Therefore, a step is formed between the stator seating part 21 and the yoke reception part 23. The depth H of the yoke reception part 23 is ranged preferably from about 0.7 to about 1.1 mm. The thickness T of the yoke 65 is ranged preferably from about 0.5 to about 0.7 mm.

With this arrangement, it is possible to assemble the yoke 65 and the rotor stator 63 so that the air gap G is formed between them, and to maintain the air gap G in an appropriate size.

The head drum assembly constructed according to an exemplary embodiment of the present invention may improve the magnetic force generated from the motor stator 63 because a predetermined size of air gap G is formed between the yoke 65 and the stator 63. If an element for improving the magnetic force in this manner, current consumption may be reduced in generating a same level of driving force. Accordingly, current consumption for driving a head drum may be reduced as compared to that needed in prior art.

This is specifically confirmed from the results listed in the following table, wherein the results were obtained from a test comparing several exemplary embodiments of the present invention with a comparative example.

TABLE

| | | |
|---|---|---|
| Air gap (G) | Consumption Current | Remark |

| | | | |
|---|---|---|---|
| 0 | mm | 0.1 | Prior art |
| 0.3 | mm | 0.070 | Embodiment 1 |
| 0.5 | mm | 0.075 | Embodiment 2 |
| 0.7 | mm | 0.084 | Embodiment 3 |

The table shows results obtained by a test performed to measure current consumed for driving a head drum assembly while varying the air gap G thereof. As is shown in the table, the current consumption of the exemplary embodiments 1 to 3 provided with air gap G is reduced as compared that of the prior art not provided with an air gap. In particular, it is appreciated that when the air gap G is 0.3 mm, the current consumption characteristic is most preferable. In this event, the consumption current is reduced approximately 30%, whereby the term for using a battery is prolonged.

From the test as described above, it may be concluded that it is preferable to maintain an air gap G at about 0.3 mm and it is effective in improving the current consumption characteristic to control the air gap within the range from about 0.2 mm to about 0.4 mm.

According to the inventive head drum assembly of a magnetic recording and reproducing apparatus as described above, consumption current for driving the head drum assembly may be reduced by providing an air gap between the motor stator and the yoke thereof.

As a result, there is an advantage in that a term for using a battery may be prolonged in an appliance employing an exemplary embodiment of the inventive head drum assembly.

While the preferred embodiments of the present invention have been shown and described in order to exemplify the principle of the present invention, the present invention is not limited to the specific embodiments. It will be understood that various modifications and changes may be made by one skilled in the art without departing from the spirit and scope of the invention as defined by the appended claims. Therefore, it shall be considered that such modifications, changes and equivalents thereof are all included within the scope of the present invention.

What is claimed is:

1. A head drum assembly of a magnetic recording and reproducing apparatus, comprising:
a fixed drum secured to a shaft;
a rotary drum rotatably fitted on the shaft to be opposite to the fixed drum, wherein a motor rotor is supported in the rotary drum;
a stator installed on the fixed drum to be opposite to the motor rotor; and
a yoke secured to the fixed drum so that a predetermined air gap is provided between the stator and the yoke.

2. The head drum assembly as claimed in claim 1, wherein
the air gap is ranged from about 0.2 mm to about 0.4 mm.

3. The head drum assembly as claimed in claim 1, wherein
a stator seating part is formed on a surface of the fixed drum faced to the rotary drum so that the stator is seated on the stator seating part; and
a yoke reception part is formed to be stepped from the stator seating part and to receive the yoke.

4. The head drum assembly as claimed in claim 3, wherein
the yoke reception part is stepped inwardly from the stator seating part.

5. The head drum assembly as claimed in claim 3, wherein
the depth of the yoke reception part is larger than the thickness of the yoke.

6. The head drum assembly as claimed in claim 5, wherein
the depth of the yoke reception part is ranged from about 0.7 mm to about 1.1 mm.

7. The head drum assembly as claimed in claim 2, wherein
a stator seating part is formed on a surface of the fixed drum faced to the rotary drum so that the stator is seated on the stator seating part; and
a yoke reception part is formed to be stepped from the stator seating part and to receive the yoke.

8. The head drum assembly as claimed in claim 7, wherein
the yoke reception part is stepped inwardly from the stator seating part.

9. A magnetic recording and reproducing apparatus, comprising:
a deck; and
a head drum assembly installed on the deck, the head drum assembly including
a fixed drum secured to a shaft;
a rotary drum rotatably fitted on the shaft to be opposite to the fixed drum, wherein a motor rotor is supported in the rotary drum;
a stator installed on the fixed drum to be opposite to the motor rotor; and
a yoke secured to the fixed drum so that a predetermined air gap is provided between the stator and the yoke.

10. The magnetic recording and reproducing apparatus as claimed in claim 9, wherein the air gap is ranged from about 0.2 mm to about 0.4 mm.

11. The magnetic recording and reproducing apparatus as claimed in claim 9, wherein
a stator seating part is formed on a surface of the fixed drum faced to the rotary drum so that the stator is seated on the stator seating part; and
a yoke reception part is formed to be stepped from the stator seating part and to receive the yoke.

12. The head drum assembly as claimed in claim 11, wherein
the yoke reception part is stepped inwardly from the stator seating part.

13. The magnetic recording and reproducing apparatus as claimed in claim 11, wherein
the depth of the yoke reception part is larger than the thickness of the yoke.

14. The magnetic recording and reproducing apparatus as claimed in claim 13, wherein
the depth of the yoke reception part is ranged from about 0.7 mm to about 1.1 mm.

15. The head drum assembly as claimed in claim 13, wherein
a stator seating part is formed on a surface of the fixed drum faced to the rotary drum so that the stator is seated on the stator seating part; and
a yoke reception part is formed to be stepped from the stator seating part and to receive the yoke.

16. The head drum assembly as claimed in claim 15, wherein
the yoke reception part is stepped inwardly from the stator seating part.
